(19) United States
(12) Patent Application Publication
(10) Pub. No.: US 2006/0220277 A1
(43) Pub. Date: Oct. 5, 2006

(54) Tape-form recording medium and manufacturing method thereof

(75) Inventors: Ryota Suzuki, Kanagawa (JP); Shinichi Sugawara, Kanagawa (JP)

Correspondence Address: SUGHRUE MION, PLLC, 2100 PENNSYLVANIA AVENUE, N.W., SUITE 800, WASHINGTON, DC, 20037, US

(73) Assignee: FUJI PHOTO FILM CO., LTD.

(21) Appl. No.: 11/396,575

(22) Filed: Apr. 4, 2006

(30) Foreign Application Priority Data
Apr. 4, 2005 (JP) 2005-108010

(51) Int. Cl. B29C 71/00

(52) U.S. Cl. 264/345

(57) ABSTRACT

A manufacturing method of a tape-form recoding medium in the present invention is configured with a raw web winding process of winding on a winding core raw web having a support body, a data recoding layer laminated on one side of the support body, and a minute convexity laminated on the other side thereof; a raw web rewinding process of rewinding on other winding cores the raw web wound on the winding core in the raw web winding core; and a heat treatment process of heating the rewound raw web and decreasing a number of a concavity not less than 30 nm in depth formed in the data recording layer in the raw web winding process to not more than 80 pieces/mm².

### BACKGROUND OF THE INVENTION

1. Field of the Invention

The present invention relates to a tape-form recoding medium and a manufacturing method thereof.

2. Description of the Related Art

As a conventional manufacturing method of a magnetic tape is known a method of: manufacturing a magnetic tape bulk roll by coating a coating liquid for forming a magnetic layer containing a magnetic material, a bonding agent, and a solvent on one side of a magnetic tape support body sent out from a magnetic tape support body bulk roll, and then orienting, drying, and winding the raw web; slitting a peripheral face of the magnetic tape bulk roll from one edge to the other edge for every tape width; and winding the magnetic tape from the slit raw web for every cassette tape, using a tape winder (for example, see paragraphs 0022 to 0024 in Japanese Patent Laid-Open Publication No. 2002-123934).

At this time a mirror-finish treatment is dispensed to the magnetic tape support body where such a coating liquid for forming a magnetic layer is coated by a calendar device, and thereafter, the support body is wound. In addition, the magnetic tape bulk roll is stored, for example, at an ambient temperature of around 70 degrees Celsius for a predetermined time (for example, around 36 hours) in a space adjusted in a state of a low humidity, and a strain of a base due to such hot curing of a coated film is relieved.

In addition, on the other side of the magnetic tape support body is formed, for example, a back coat layer containing carbon black like a rough particle of 150 to 300 nm in average particle size. Then forming a minute convexity on a surface of the back coat layer and decreasing a contact area by such the carbon black like the rough particle, a decrease of a friction coefficient and a running stability are improved.

Whereas, if the minute convexity is formed on the surface of the back coat layer, it contacts the surface of the magnetic layer in a step of winding the magnetic tape support body and manufacturing the magnetic tape bulk roll. Then, if leaving the magnetic tape bulk roll for a long time in the state and/or heating it, there is a problem that a minute concavity results in being formed on the surface of the magnetic layer.

If there exists a concavity on a surface of a data recording layer of a tape-form recoding medium represented by such the magnetic tape described above, an occurrence frequency of a dropout (signal dropout) in reading/writing data increases, and thereby a quality of the tape-form recoding medium results in lowering. In addition, because as a track width narrows, an influence of such the concavity becomes larger, it is a large obstacle in increasing a recording capacity (recording density) of the tape-form recoding medium.

Consequently, a tape-form recoding medium more superior in running stability and less in occurrence frequency of a dropout, and a manufacturing method thereof are strongly requested. In addition, a tape-form recoding medium, where even if a recording capacity is increased, the occurrence frequency of the dropout does not increase, and a manufacturing method thereof are strongly requested.

### SUMMARY OF THE INVENTION

A first aspect of the present invention is a manufacturing method of a tape-form recoding medium comprising: a raw web winding process of winding on a winding core raw web having a support body, a data recoding layer laminated on one side of the support body, and a minute convexity laminated on the other side thereof; a raw web rewinding process of rewinding on other winding cores the raw web wound on the winding core in the raw web winding core; and a heat treatment process of heating the rewound raw web and decreasing a number of a concavity not less than 30 nm in depth formed in the data recording layer in the raw web winding process to not more than 80 pieces/mm².

In accordance with such the method it is enabled to heat rewound raw web, thereby to expand a data recording layer, and to recover a concavity not less than 30 nm in depth formed in the data recording layer in a raw web winding process. At this time, if adjusting a tension in winding and a winding time and making a number of a concavity not more than 80 pieces/mm², it is enabled to make a dropout time less.

Here, a data recording layer may also be any one of a recording layer for recording a change of a magnetic field as a signal and an optical recording layer containing a metal material and an organic dye recording material that cause a crystalline change (phase change) by radiation of a laser light.

In addition, a width of raw web may be any one of a width (for example, around 1 m) of being able to form a plurality of tape-form recoding media by slitting and a width (for example, ½ inch (12.65 mm)) corresponding to one tape-form recoding medium.

In addition, a winding core is not specifically limited if it can wind raw web, and for example, it is enabled to use such a long bar-form shaft and a short columnar hub. In a case of using a hub may be one (hereinafter referred to as taper hub in some case) with a taper on a tape winding side or another one without the taper. In a case of using the taper hub it is enabled to give a curvature to a tape-form recoding medium at the same time of a recovery of a concavity. If curving the tape-form recoding medium in a width direction along a longitudinal direction, a winding form in winding the medium becomes preferable, an edge damage is relieved, running of the medium becomes stable, and thus a performance of servo tracking is improved.

A second aspect of the present invention is in the raw web rewinding process the manufacturing method of the tape-form recoding medium according to the first aspect of the invention, wherein a ratio (D1/D2) of a diameter D1 of the other winding cores to a diameter D2 of a pancake formed by rewinding the raw web on the other winding cores is in a range of an equation (1) below:
0.5≦D1/D2<1.0 Equation (1)

According to a research of the inventors et al., if limiting the ratio (D1/D2) of the diameter D1 of the other winding cores to the diameter D2 of a pancake formed by rewinding raw web on the other winding cores, it is proved that a concavity formed on a surface of a data recording layer more easily recovers.

In other words, if limiting the ratio (D1/D2) of the diameter D1 of other winding cores to the diameter D2 of a pancake to the range of the equation (1), a winding number of raw web with respect to a diameter of other winding cores results in being limited. Because the larger a pushing force (surface pressure) between a data recording layer of raw web wound on other winding cores and a back coat layer wound on the recording layer becomes the more a winding number becomes, the winding number is limited to the range, and thereby, the pushing force (surface pressure) between the data recording layer and the back coat layer results in being limited. Therefore, the concavity is enabled to recover by heat treatment thereafter. In addition, because the pushing force is limited, a minute convexity does not further dig into the surface of the data recording layer.

A third aspect of the present invention is the manufacturing method of the tape-form recoding medium in the raw web rewinding process according to any one of the first and second aspects, wherein a tension T per unit tape width in rewinding the raw web on the other winding cores is in a range of an equation (2) below:
7.7×10⁻² N/mm≦T≦1.55×10⁻¹ N/mm. Equation (2)

In accordance with such the method, because the tension T per unit tape width in rewinding raw web on other winding cores is limited to the range of the equation (2), it is enabled to limit a pushing force between a data recording layer and a back coat layer to a range preferable for recovering a concavity. Therefore, it is enabled to effectively recover the concavity of a surface of the data recording layer. Meanwhile, if the tension T exceeds 1.55×10⁻¹ N/mm (15.8 gf/mm), some minute convexity newly digs into a data recording layer; if it is smaller than 7.7×10⁻² N/mm (7.9 gf/mm), there exists some case of not being able to efficiently rewind raw web on other winding cores.

A fourth aspect of the present invention is the manufacturing method of the tape-form recoding medium according to any one of the first to third aspects, the method further comprising a raw web slitting process of slitting the raw web, matching a desired width of the tape-form recoding medium.

In accordance with such the method, even in a case of using wide raw web (for example, around 1 m), because of slitting it into a width (for example, 12.65 mm) of a tape-form recoding medium and thereafter winding the slit raw web, it is enabled to narrow a width of raw web in a raw web heat treatment process. Therefore, a heating effect early results in reaching till a middle portion in a width direction of the raw web without a fluctuation, it is enabled to effectively recover a concavity of a surface of a data recording layer.

A fifth aspect of the present invention is a tape-form recoding medium manufactured by the manufacturing method of the tape-form recoding medium according to any one of the first to fourth aspects.

In accordance with such the tape-form recoding medium it is enabled to decrease a dropout time in reproducing the medium.

Meanwhile, in a case that a tape-form recoding medium manufactured by the manufacturing method is a magnetic recoding medium, the magnetic recoding medium is preferably used in a system where a track width of a reproducing head is not more than 8 μm. Because the more an influence on a concavity of a data recording layer the narrower the track width, if applying the present invention to a magnetic recoding medium used in such the system, it is enabled to decrease an occurrence of a dropout.

### BRIEF DESCRIPTION OF THE DRAWINGS

FIGS. 1A and 1B are illustration drawings schematically illustrating manufacturing equipment of a magnetic tape; FIGS. 1A and 1B respectively show apparatuses corresponding from a raw web manufacturing process to a strain relief process and from a raw web slitting process to a raw web heat treatment process.

FIGS. 2A and 2B are enlarged section drawings showing a configuration of raw web and a magnetic tape; FIGS. 2A and 2B respectively show the raw web after a strain relief process and the magnetic tape after a raw web heat treatment process.

FIG. 3 is a front view showing a pancake.

FIG. 4 is a flowchart showing a manufacturing method of a magnetic tape related to an embodiment of the present invention.

FIG. 5 is a table showing a test condition and measurement result of an example and an comparison example.

### BEST MODE FOR CARRYING OUT THE INVENTION

Here will be described a best mode for carrying out the present invention in detail, referring to drawings as needed. In a description a same symbol will be appended to a same component, and a duplicated description will be omitted. Here, as an example will be described a manufacturing method of a magnetic tape, one of a tape-form recoding medium.

<Manufacturing Equipment of Magnetic Tape>

Firstly will be described manufacturing equipment of a magnetic tape for realizing a manufacturing method of the magnetic tape related to the present invention.

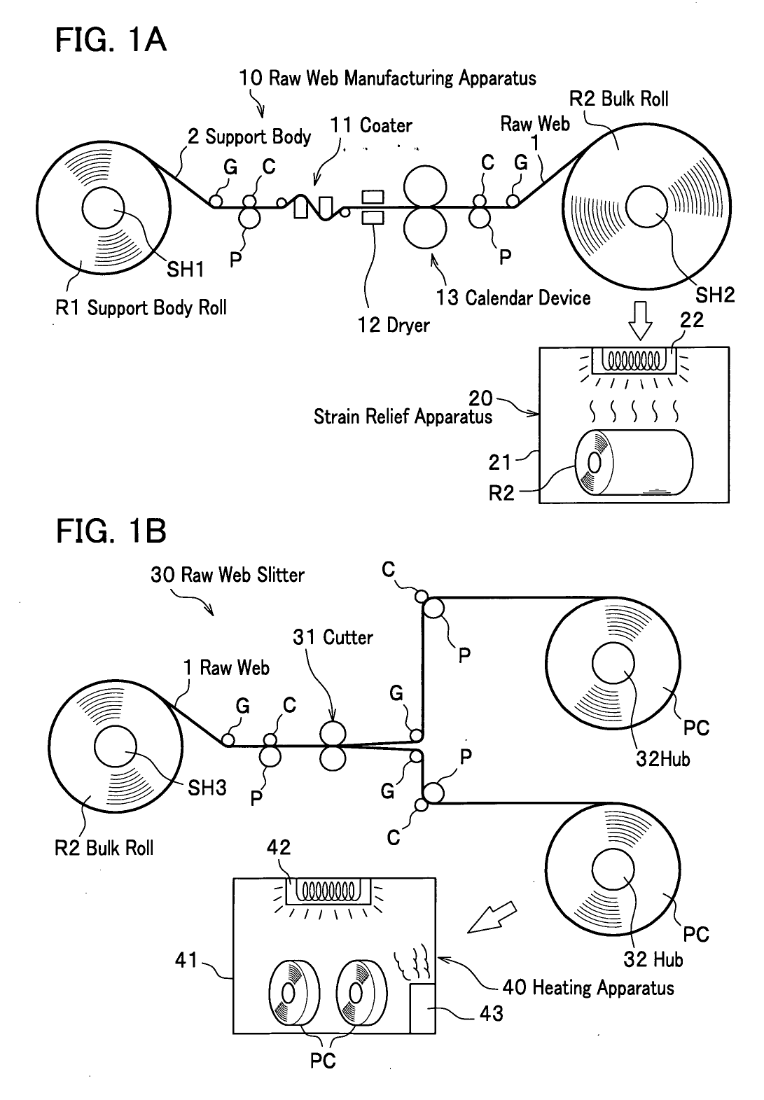

The manufacturing equipment of the magnetic tape is as shown in FIGS. 1A and 1B configured with a raw web manufacturing apparatus 10 for manufacturing raw web 1, a strain relief apparatus 20 for reducing a strain of the raw web 1, a raw web slitter 30 for slitting the raw web 1 into a width of a magnetic tape MT, and a heating apparatus 40 for heating the slit raw web 1.

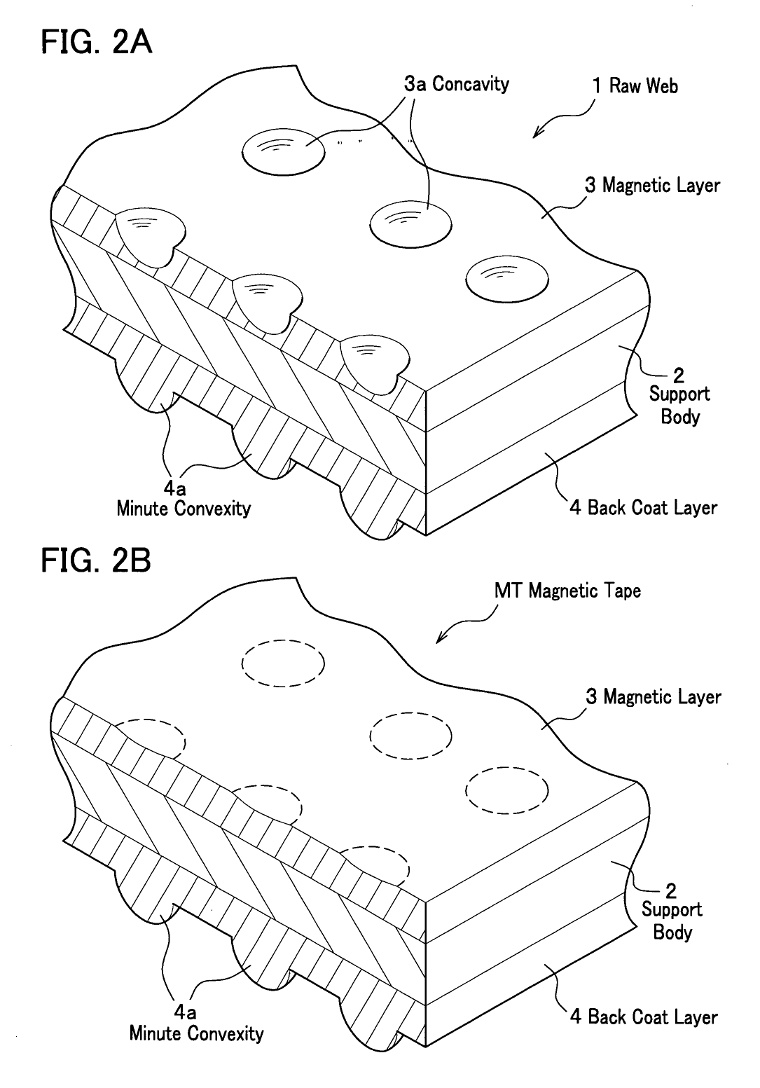

The raw web manufacturing apparatus 10 comprises, as shown in FIG. 1A, a sending-out shaft SH1 for sending out a support body 2, a coater 11 for coating a magnetic-layer-use paint “and a back-coat-layer-use paint on the support body 2, a dryer 12 for drying the coated paints, a calendar device 13 for smoothly processing a surface of the dried magnetic-layer-use paint, and a winding shaft SH2 of a winding core for winding the support body 2 (that is, raw web 1) where a magnetic layer 3 and a back coat layer 4 (see FIG. 2) are formed. In addition, at an upstream side of the coater 11 and a downstream side of the calendar device 13 are respectively provided pinch rollers P and capstan rollers C for carrying the raw web 1 or the support body 2. In addition, on a running path of the raw web 1 and the support body 2 are provided guide rollers G, regulating the running path.

The sending-out shaft SH1 is a shaft for attaching a support body roll R1 consisting of the support body 2 wound around like a roll, and sends out the support body 2 onto a running path by being rotated with a driving apparatus (not shown). The sent-out support body 2 is adapted to be carried to the coater 11 by the pinch roller P and the capstan roller C.

Here, the support body 2 is a film-form member becoming a base of the magnetic tape MT, and it is preferable to use, for example, a synthetic resin film such as polyesters, polyolefins (for example, polypropylene), cellulose derivatives, polycarbonate, polyamide, polyimide.

The coater 11 is an apparatus for coating a magnetic-layer-use paint on a front side of the support body 2 and a back-coat-layer-use paint on a back side. The coater 11 can be selected out of known apparatuses as needed. For example, although not shown, respectively disposing two members comprising through holes for vomiting a paint so as to contact the front side and back side of the support body 2 and making the two members run while making the front and back sides contact the two members for vomiting the paint from the through holes, and thereby, it also may be adapted to coat the paint on the support body 2.

Here, the magnetic-layer-use paint is configured to mainly contain a ferromagnetic powder, a bonding agent, and an organic solvent. In addition, the back-coat-layer-use paint is configured to mainly contain carbon black and a bonding agent for forming minute convexities 4a (see FIGS. 2A and 2B). A particle diameter of the carbon black is preferably around 150 to 300 nm. In addition, according to a method similar to the above, an under coat layer and/or a non-magnetic layer may also be formed between the support body 2 and the magnetic layer 3. Meanwhile, to the back-coat-layer-use paint are added a dispersing agent, a lubricant, an antistatic agent, a plasticizer, a stabilizer, and antirust.

As a ferromagnetic powder can be used, for example, a ferromagnetic iron oxide particle such as γ-Fe₂O₃, Fe₃O₄, and cobalt coated γ-Fe₂O₃; a ferromagnetic dioxide chrome particle; a ferromagnetic metal particle consisting of metal such as Fe, Co, and Ni, and alloy containing these; a hexagonal ferrite particulate like a hexagonal plate; and the like.

In addition, as a bonding agent can be used a polymer such as urethane, vinyl chloride, vinyl acetate, vinyl alcohol, vinylidene chloride, acrylic ester, styrene, butadiene, and acrylic nitrile; a copolymer where not less than two kinds of these are combined; polyester resin; epoxy resin; and the like.

As an organic solvent can be used such ethers, esters, ketones, aromatic hydrocarbon, aliphatic hydrocarbon, and chlorinated hydrocarbon.

The dryer 12 is an apparatus for drying and curing a magnetic-layer-use paint and a back-coat-layer-use paint coated on the support body 2. The dryer 12 is adapted, for example, to add heat to the support body 2 passing inside the dryer 12 and to dry the paints coated on the support body 2. The paints is dried and cured, and thereby, the magnetic layer 3 and the back coat layer 4 are respectively formed on the front and back sides of the support body 2.

The calendar device 13 is an apparatus for smoothing the front side of the magnetic layer 3. The calendar device 13 comprises two rollers, and is adapted to pinch and pressurize between the rollers the support body 2 where the magnetic layer 3 and the back coat layer 4 are formed. Meanwhile, a surface roughness of the magnetic layer 3 and the back coat layer 4 can be adjusted by such a material, surface property, and pressure of the rollers used. Thus the front side of the magnetic layer 3 becomes smooth and the raw web 1.

The winding shaft SH2 of a winding core winds the raw web 1 manufactured. The winding shaft SH2 is adapted to wind the raw web 1 carried by being rotated with a driving apparatus (not shown). The wound raw web 1 becomes a bulk roll R2. The driving apparatus is configured to be able to adjust a rotation torque by a torque adjustment mechanism (not shown) and thereby to adjust a winding tension of the raw web 1. As a driving apparatus, for example, such a voltage control alternating motor can be used. In addition, as a torque adjustment mechanism, for example, a voltage control apparatus such as an OP (Operational) amp can be used.

The raw web 1 is manufactured by such the raw web manufacturing apparatus 10, wound on the winding shaft SH2, and thereby, the minute convexities 4a (see FIGS. 2A and 2B) formed on the surface of the back coat layer 4 results in being pushed to that of the opposing magnetic layer 3.

The strain relief apparatus 20 is an apparatus for reducing a strain accumulated in the raw web 1. The strain relief apparatus 20 comprises a storing unit 21 for storing the bulk roll R2 and a heater 22 for heating an inner space of the storing unit 21. For example, if a paint coated on the support body 2 is dried and cured and/or the support body 2 itself is heated, a strain is accumulated in the raw web 1. The strain relief apparatus 20 relieves a stress by heating the raw web 1, and thereby removes the strain.

FIG. 2A is a drawing showing the raw web 1 after taken out of the strain relief apparatus 20.

Because the back coat layer 4 contains carbon black of a predetermined particle diameter, the minute convexities 4a are formed with the carbon black. By such the minute convexities 4a is decreased a friction between the magnetic layer 3 and the back coat layer 4, and a running stability of the magnetic tape MT is improved.

On the other hand, because the raw web 1 is wound like a roll, the minute convexities 4a of the back coat layer 4 of the raw web 1 wound on the front side of the magnetic layer 3 result in contacting that of the magnetic layer 3 of the raw web 1 wound inside (shaft side). Then because the raw web 1 is warmed by the strain relief apparatus 20 in a state of the bulk roll R2 in order to remove an accumulated strain, it tends to be deformed. Therefore, as shown in FIG. 2A, concavities 3a corresponding to the convexities 4a result in being formed on the front side of the magnetic layer 3.

A description will be continued, returning to FIGS. 1A and 1B.

The raw web slitter 30 comprises, as shown in FIG. 1B, a sending-out shaft SH3 where the bulk roll R2 is attached, a cutter 31 for slitting the raw web 1, hubs 32, 32 of other winding cores. In addition, at upstream sides of the cutter 31 and the hubs 32, 32 are disposed the pinch rollers P and the capstan rollers C, respectively. In addition, at the downstream side of the cutter 31 are provided the guide rollers G for leading the slit raw web 1 to each of the hubs 32, 32.

The sending-out shaft SH3 is a shaft for attaching the bulk roll R2 where a strain is relieved, and sends out the raw web 1 onto a running path by being rotated by a driving apparatus (not shown). The sent-out raw web 1 is adapted to be carried to the cutter 31 by the pinch roller P and the capstan roller C.

The cutter 31 slits the raw web 1 into a width of the magnetic tape MT, and in the embodiment, is configured with a round knife cutter. The slit raw web 1 is led to the hubs 32, 32 by the guide rollers G, G, respectively.

Each of the hubs 32, 32 of other winding cores winds the raw web 1 slit into a same width. The hub 32 is connected to a driving apparatus (not shown) and adapted to be rotatable. The driving apparatus is configured to be able to adjust a rotation torque by a torque adjustment mechanism (not shown) and thereby to adjust a tension for winding the raw web 1. As a driving apparatus, for example, such a voltage control alternating motor can be used. In addition, as a torque adjustment mechanism, for example, a voltage control apparatus such as an OP amp can be used.

At this time the tension T in winding the raw web 1 on the hub 32 is preferable to be in a range of the equation (2) below:
7.7×10⁻² N/mm≦T≦1.55×10⁻¹ N/mm. Equation (2)

If the tension T is in such the range, it is enabled to effectively recover the concavities 3a formed in the magnetic layer 3. Meanwhile, if the tension T exceeds 1.55×10⁻¹ N/mm (15.8 gf/mm), the minute convexities 4a result in digging into the front side of an opposing magnetic layer 3 again, and new concavities 3a are formed. In addition, if the tension T is smaller than 7.7×10⁻² N/mm (7.9 gf/mm), it becomes difficult to preferably hold the raw web 1 in a shape of the pancake PC.

As shown in a front view of the pancake PC, although the more a winding number of the raw web 1 becomes the less the ratio (D1/D2) of the diameter D1 of the hub 32 to the diameter D2 of the pancake PC becomes, it is proved according to a research of the inventors et al. that if the ratio (D1/D2) becomes less than 0.5, a pushing force (surface pressure) between the magnetic layer 3 and the back coat layer 4 becomes larger than requested and that it becomes difficult for the concavities 3a of the magnetic layer 3 to recover.

Accordingly, a size of the pancake PC for the hub 32 is preferably adjusted so that the ratio (D1/D2) of the diameter D1 of the hub 32 to the diameter D2 of the pancake PC becomes in a range of the equation (1) below:
0.5≦D1/D2<1.0 Equation (1)

The heating apparatus 40 recovers the concavities 3a formed on the magnetic layer 3 of the raw web 1 by heating (performing a heat treatment for) the raw web 1. As shown in FIG. 1B, the heating apparatus 40 comprises a storing unit 41 for storing pancakes PC, the heater 42 for heating a space within the storing unit 41, and a humidifier 43 for giving a humidity to the space within the unit 41. It is preferable in the storing unit 41 to use a material higher in adiathermancy and to form a size that can store a plurality of pancakes PC.

A temperature within the storing unit 41 is preferably around 40 to 60 degrees Celsius, and more preferably around 50 to 60 degrees Celsius. In addition, a humidity is preferably around 20 to 80%, and more preferably around 40 to 60%. In addition, a storing time is preferably around 12 to 72 hours, and more preferably around 12 to 48 hours. The raw web 1 is left inside the storing unit 41 in a state of the pancakes PC, and the concavities 3a are adapted to recover. Meanwhile, because it is preferable that there exists a proper humidity in order to recover the concavities 3a, in the embodiment is provided the humidifier 43 inside the heating apparatus 40.

FIG. 2B is an enlarged perspective view showing the magnetic tape MT after heated by the heating apparatus 40.

The raw web 1 is relieved in stress by being heated, and as shown in FIG. 2B, the concavities 3a formed on the surface of the magnetic layer 3 gradually recover. In the embodiment, in order to make a friction coefficient in a running tape MT within a predetermined range, it is adapted that a number of concavities 3a not less than 30 nm in depth becomes not more than 80 pieces/mm² by: setting a containment amount of carbon black of a back-coat-layer-use paint; making the ratio (D1/D2) of the diameter D1 of the hub 32 to the diameter D2 of the pancake PC within the range of the equation (1); and further adjusting the tension T so as to become within the range of the equation (2) in winding the raw web 1 on the hub 32.

Subsequently, a manufacturing method of the magnetic tape MT will be described.

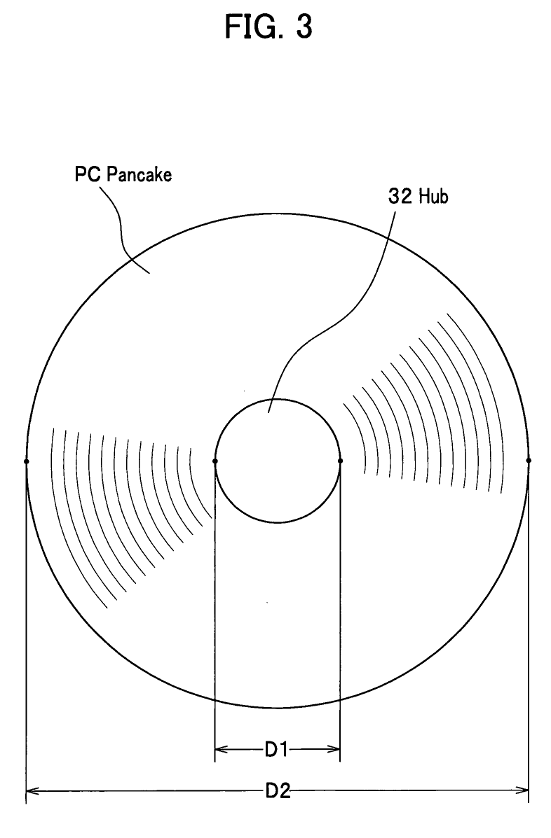

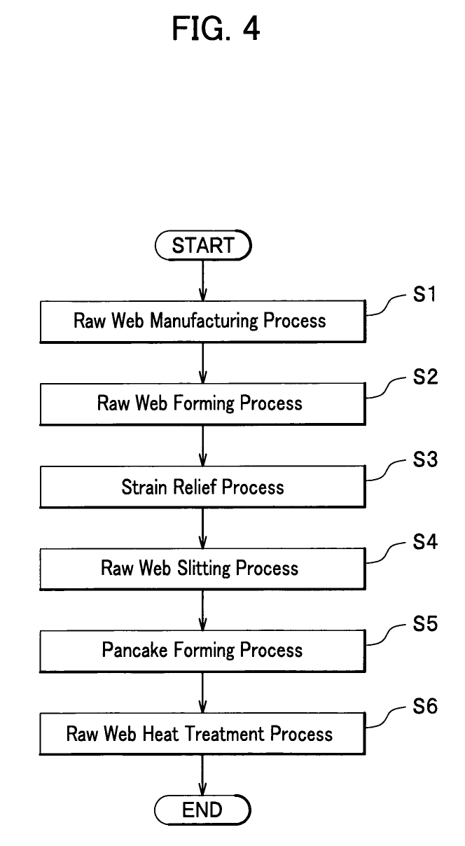

As shown in FIG. 4 (see FIGS. 1A to 3 as needed), the manufacturing method of the magnetic tape MT related to the embodiment is configured with: a raw web manufacturing process S1 of forming the magnetic layer 3 and the back coat layer 4 on the support body 2; a raw web forming process S2 (raw web winding process) of winding the raw web 1 manufactured and forming the bulk roll R2; a strain relief process S3 of reducing a strain accumulated in the raw web 1 in the manufacturing processes; a raw web slitting process S4 of cutting the raw web 1 into a width of the magnetic tape MT; a pancake forming process S5 (raw web rewinding process) of winding the slit raw web 1 on the hub 32 and forming the pancake PC; and a raw web heat treatment process S6 of performing a heat treatment for the raw web 1 made the pancake PC and recovering the concavities 3a of the magnetic layer 3. Each of these processes is realized by the manufacturing equipment of the magnetic tape MT shown in FIGS. 1A and 1B. Hereafter will be described the manufacturing method of the magnetic tape MT in detail, referring to FIGS. 1A to 4.

<<Raw Web Manufacturing Process>>

Firstly, the support body 2 sent out from the support body roll R1 is, as shown in FIG. 1A, carried by the pinch roller P and the capstan roller C to the coater 11. The coater 11 coats a magnetic-layer-use paint on the front side of the support body 2 and a back-coat-layer-use paint on the back side thereof. The support body 2 where the magnetic-layer-use paint and the back-coat-layer-use paint are coated is carried to the dryer 12. The dryer 12 dries and cures the magnetic-layer-use paint and the back-coat-layer-use paint. Thus, on the front side and back side of the support body 2 are formed the magnetic layer 3 and the back coat layer 4, respectively. The support body 2 where the magnetic layer 3 and the back coat layer 4 are formed is carried to the calendar device 13, and the front side of the magnetic layer 3 is smoothed by the calendar device 13. Thus the raw web 1 is manufactured.

At this time as the back-coat-layer-use paint is used a paint where a containment amount of carbon black is adjusted for forming the minute convexities 4a. If such the paint is cured, the minute convexities 4a result in being formed on the surface of the back coat layer 4.

<<Raw Web Forming Process (Raw Web Winding Process)>>

The raw web 1 where the front side of the magnetic layer 3 is smoothed is wound with a predetermined tension by the winding shaft SH2, and becomes the bulk roll R2. Thus the minute convexities 4a of the back coat layer 4 are pushed to the front side of the magnetic layer 3 and result in digging into it.

<<Strain Relief Process>>

The bulk roll R2 is stored within the storing unit 21 of the strain relief apparatus 20 and is left for around 36 hours in a space made a state of, for example, a temperature of 70 degrees Celsius and a lower humidity. Thus a strain accumulated in the raw web 1 is relieved. On the other hand, because the front side of the magnetic layer 3 results in being warmed in a state of being pushed to the minute convexities 4a of the back coat layer 4, the concavities 3a result in being formed at a portion where the front side contacts the minute convexities 4a (see FIG. 2A).

<<Raw Web Slitting Process>

The bulk roll R2 where a strain is relieved is set, as shown in FIG. 1B, on the sending-out shaft SH3 of the raw web slitter 30. The raw web 1 sent out from the bulk roll R2 is carried to the cutter 31 by the pinch roller P and the capstan roller C. The cutter 31 slits the carried raw web 1 so as to be equal to a width of the magnetic tape MT.

<<Pancake Forming Process (Raw Web Rewinding Process)>>

The slit raw web 1 is, as shown in FIG. 1B, branched along the guide rollers G and is wound on each of the hubs 32, 32. At this time, adjusting the ratio (D1/D2) of the diameter D1 of the hub 32 to the diameter D2 of the pancake PC to be in the range of the equation (1) and the tension T per unit tape width in winding the raw web 1 on the hub 32 to be in the range of the equation (2), the raw web 1 is adapted to be wound on the hub 32. Thus a force by which the back coat layer 4 pushes the magnetic layer 3 is preferably adjusted, and a recovery of the concavities 3a becomes easier.

<<Raw Web Heat Treatment Process>>

The pancakes PC, PC are stored within the storing unit 41 of the heating apparatus 40, and are left for around 24 hours in a space adjusted to, for example, a temperature of 60 degrees Celsius and a humidity of 50%. Because in the raw web 1 the tension T in winding the raw web 1 on the hub 32 is limited to the range of the equation (1) and further the ratio (D1/D2) of the diameter D1 of the hub 32 to the diameter D2 of the pancake PC is limited to the range of the equation (2), a number of the concavities 3a not less than 30 nm in depth recovers to not more than 80 pieces/mm² by such the heat treatment.

Thus, in accordance with the manufacturing method of the magnetic tape MT related to the embodiment, because a number of the concavities 3a not less than 30 nm in depth becomes not more than 80 pieces/mm² after a heat treatment, it is enabled to manufacture the magnetic tape MT superior in running stability and less in occurrence frequency of a dropout.

### EXAMPLE

Although examples are described below, the present invention is not limited thereto. Meanwhile, “part” in the examples and comparison examples shows “weight part.”

### Example 1

Out of undercoat layer paint compositions below, kneading a first agent with a kneader, then adding a second agent to the first agent and stirring it, dispersing it by a sand mill with making a staying time 90 minutes, and after adding a third agent thereto and stirring and filtering it, it was made an undercoat layer paint.

<<Undercoat Layer Paint Composition>>

(First Agent)

Iron oxide powder (particle diameter: 0.15×0.02 μm): 70 parts
Alumina (α ratio: 50%, particle diameter: 0.05 μm): 8 parts
Carbon black (particle diameter: 15 nm): 25 parts
Stearic acid/butyl stearate (50/50): 3.0 parts
Vinyl chloride copolymer (containing-SO₃Na group: 1.2×10⁻⁴ equivalent/g): 10 parts
Polyester urethane resin (Tg: 40 degrees Celsius, containing-SO₃Na group: 1×10⁻⁴ equivalent/g): 4.4 parts
Cyclohexanone: 30 parts
Methylethylketone: 60 parts
   (Second Agent)
Butyl stearate: 3 parts
Oleyl oleate: 5 parts
Cyclohexanone: 40 parts
Methylethylketone: 60 parts
Toluene: 15 parts
   (Third Agent)
Polyisocyanate: 1.5 parts
Cyclohexanone: 8 parts
Methylethylketone: 18 parts
Toluene: 8 parts

In addition, kneading a following first agent of magnetic-layer-use paint compositions, then dispersing it by a sand mill with making a staying time 60 minutes, and adding a second agent of the paint composition thereto and stirring and filtering it, thus it was made a magnetic-layer-use paint.

<<Magnetic-Layer-Use Paint Composition>>

(First Agent)

Ferromagnetic metal powder (Co/Fe, 30 at %; Y/(Fe+Co), 3 at %; Al/(Fe+Co), 5 wt %; Ca/Fe, 0.002; σs, 155 A·m²/kg; Hc, 188.2 kA/m; photo curing, 9.4; long axis length, 0.10 μm): 100 parts

Vinyl chloride hydroxypropyl acrylate copolymer (containing-SO₃Na group: 0.7×10⁻⁴ equivalent/g): 130 parts

Polyester urethane resin (containing-SO₃Na group: 1×10⁻⁴ equivalent/g): 5.5 parts

α-alumina (average particle diameter: 0.15 em): 12 parts

α-alumina (average particle diameter: 0.05 μm): 4 parts

Carbon black (average particle diameter, 50 nm; DBP (dibutyl phthalate) oil absorption amount, 72 cc/100 g): 40 parts

Methyl acid phosphate: 2 parts

Stearic acid: 1.5 parts

Oleyl oleate: 5 parts

Cyclohexanone: 70 parts

Methylethylketone: 250 parts

(Second Agent)

Polyisocyanate: 2.0 parts

Methylethylketone: 167 parts

Furthermore, dispersing back-coat-layer-use paint compositions by a sand mill with making a staying time 60 minutes, and then adding 18 parts of polyisocyanate, a back-coat-layer-use paint was adjusted.

<<Back-Coat-Layer-Use Paint Composition>>

Carbon black (particle diameter: 20 nm): 80 parts

Carbon black (particle diameter: 290 nm): 10 parts

Iron oxide (long axis length: 0.1 μm, axis ratio: about 10): 10 parts

Nitrocellulose: 45 parts

Polyurethane resin (containing-SO₃Na group): 30 parts

Cyclohexanone: 260 parts

Methylethylketone: 525 parts

Tetrahydrofuran: 80 parts

Coating the undercoat layer paint on the support body 2 consisting of a polyethylene naphthalate film (thickness, 5.0 μm; longitudinal direction strength=6.5 Gpa, longitudinal direction strength/width direction strength=1.3 manufactured by Teijin Ltd.) so that a thickness thereof after drying and a calendar treatment became 1.5 μm and further coating the magnetic-layer-use paint with dry-on-wet so that a thickness after a magnetic field orientation treatment, drying, and a calendar treatment became 0.12 μm, treating a magnetic field orientation, and then drying with using a dryer, raw web (hereinafter referred to as “magnetic sheet” in some case) of a magnetic tape was obtained. Meanwhile, the magnetic field orientation treatment was performed, providing two N—N opposing magnet (5 kG) from a position of 50 cm before a dried position by touching a coated film within the dryer by finger. A coating speed was made 300 m/min.

In addition, the back-coat-layer-use paint was coated on a backside of the magnetic layer so that a thickness thereof became 0.4 μm after drying and a calendar treatment, and was dried.

Performing a mirror finish treatment for the magnetic sheet thus obtained by a seven-high calendar consisting of metal rolls under a condition of a temperature of 100 degrees Celsius and a linear pressure of 2 kN/cm (200 kg/cm) and leaving the magnetic sheet in a space of a temperature of 60 degrees Celsius for 48 hours in a state (state of the bulk roll R2) of being wound on a core, a strain relief treatment was performed.

Thereafter slitting such the magnetic sheet into a width of 12.65 mm (½ inch), further leaving it in a space of a temperature of 50 degrees Celsius for 24 hours, performing a heat treatment for it, winding it in a cassette with the tension T of 7.7×10⁻²N (7.9 gf/mm), and thus making a magnetic tape cartridge, it was made an example 1.

In the example 1 the ratio (D1/D2) of the diameter D1 of a hub to the diameter D2 of a pancake formed by winding raw web on the hub was made “0.6.”

In addition, when measuring a number of concavities not less than 30 nm in depth on the front side of the magnetic layer before the heat treatment, it was 112 pieces/mm². The number of the concavities was measured with an optical interference meter system for measuring a surface roughness from an interference fringe generated by interference between a reflection light and a reference light from a specimen. A measurement condition is shown below:

(1) Using a three-dimensional surface structure analysis microscope (NewView 5010 manufactured by ZYGO Corp.) and making an objective lens 20 magnifications and a zoom magnification 1.0, a range of 346 μm×258 μm was measured.

(2) Slicing the magnetic layer in a plane parallel with a so called square average surface separated by not less than 30 nm from the average surface where a deviation and square average sum of a surface of the magnetic layer become equal, a number of countable concavities was measured.

(3) Performing the above measurement three times for one specimen while changing a view, an average value thereof was made the number of the concavities.

### Example 2

Except that a number of concavities of a magnetic layer before a heat treatment was 90 pieces/mm², by making a magnetic tape cartridge same as in the example 1, it was made an example 2. Meanwhile, the number of the concavities was adjusted by winding tension in the raw web manufacturing apparatus 10.

### Example 3

Making a magnetic tape cartridge under the same condition as in the example 2, it was made an example 3. Meanwhile, even under the same condition as in the example 2, a variation occurs in a number of concavities. after a heat treatment. In the example 2 the number of the concavities was 56 pieces/mm² after the heat treatment; whereas, in the example 3 the number was 78 pieces/mm² after the heat treatment.

### Example 4

Except for making it “0.8” the ratio (D1/D2) of the diameter D1 of a hub to the diameter D2 of a pancake and making it 179 pieces/mm² a number of concavities of a magnetic layer before a heat treatment, by making a magnetic tape cartridge same as in the example 1, it was made an example 4.

### Example 5

Except for making it 1.55×10⁻¹ N/mm (15.8 gf/mm) the tension T in winding raw web on a hub and making it 34 pieces/mm² a number of concavities of a magnetic layer before a heat treatment, by making a magnetic tape cartridge same as in the example 1, it was made an example 5.

### Comparison Example 1

Making it 0.4” the ratio (D1/D2) of the diameter D1 of a hub to the diameter D2 of a pancake, it 6.2×10⁻² N/mm (6.3 gf/mm) the tension T in winding raw web on a hub, it 112 pieces/mm² a number of concavities of a magnetic layer before a heat treatment, and further without performing the heat treatment, making a magnetic tape cartridge same as in the example 1, it was made a comparison example 1.

### Comparison Example 2

Except for making it 224 pieces/mm² a number of concavities before a heat treatment, making a magnetic tape cartridge same as in the example 1, it was made a comparison example 2.

### Comparison Example 3

Except for making it 1.94×10⁻¹ N/mm (19.8 gf/mm) the tension T in winding raw web on a hub and making it 134 pieces/mm² a number of concavities before a heat treatment, by making a magnetic tape cartridge same as in the example 1, it was made a comparison example 3.

### Comparison Example 4

Except for making it “0.4” the ratio (D1/D2) of the diameter D1 of a hub to the diameter D2 of a pancake and making it 134 pieces/mm² a number of concavities before a heat treatment, by making a magnetic tape cartridge same as in the example 1, it was made a comparison example 4.

### Comparison Example 5

Making it “0.4” the ratio (D1/D2) of the diameter D1 of a hub to the diameter D2 of a pancake, it 7.7×10⁻² N/mm (7.9 gf/mm) the tension T in winding raw web on a hub, it 90 pieces/mm² a number of concavities before a heat treatment, and further without performing the heat treatment, by making a magnetic tape cartridge same as in the example 1, it was made a comparison example 5.

### Comparison Example 6

Making it “0.6” the ratio (D1/D2) of the diameter D1 of a hub to the diameter D2 of a pancake, it 6.2×10⁻² N/mm (6.3 gf/mm) the tension T in winding raw web on a hub, it 56 pieces/mm² a number of concavities before a heat treatment, and further without performing the heat treatment, by making a magnetic tape cartridge same as in the example 1, it was made a comparison example 6.

Setting in a tape running system magnetic tape cartridges of the examples 1 to 5 and the comparison examples 1 to 6 thus made, a single wave of recording frequency 6 MHz was recorded.

With respect to the magnetic tape cartridges thus made, using a read head (MR head) where a magnetoresistance effect element having a read width corresponding to a track width of 5 μm, 8 μm, and 14 μm is mounted, a signal was read. At this time, determining it a dropout a case that an output lowering not more than 50% of an average output continues not less than 0.2μ second, a dropout time was measured across a whole length of each of the magnetic tape cartridges. After then, converting the time to per meter of a read track length, it was compared.

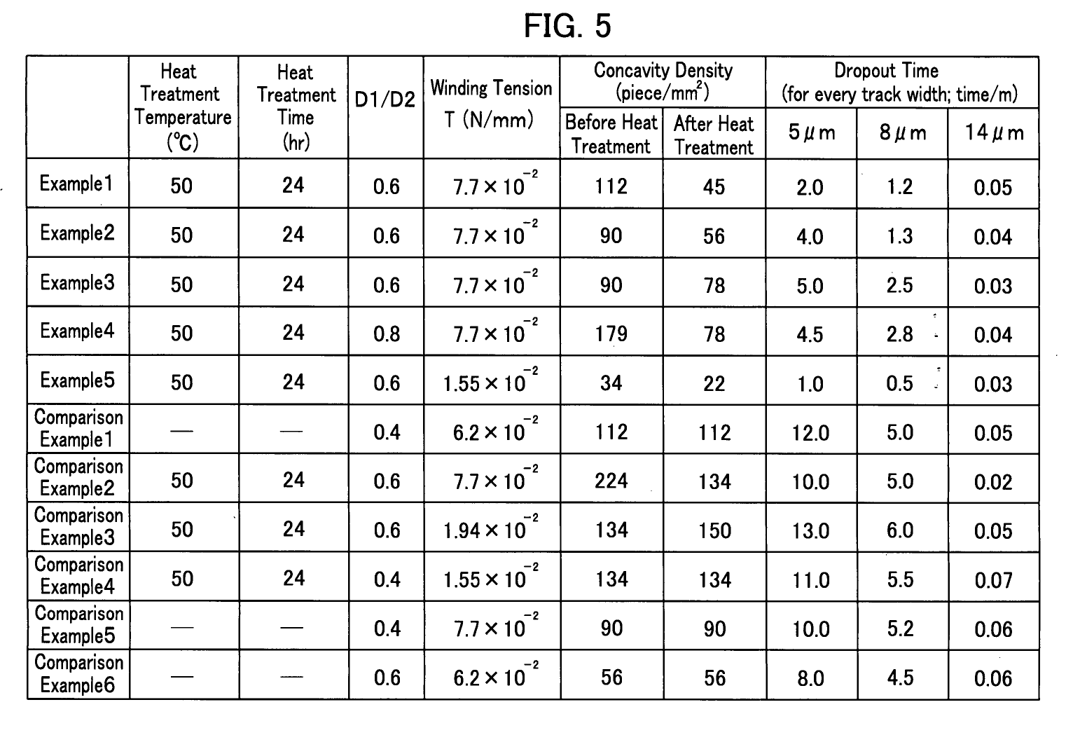

In FIG. 5 is shown a measurement result of the examples 1 to 5 and the comparison examples 1 to 6.

According to the examples 1 to 5 as shown in FIG. 5, it is proved that: a number of concavities not less than 30 nm in depth after a heat treatment is recovered to not more than 80 pieces/mm2; whereas in the comparison examples 1 to 6, the number is not recovered. Particularly, according to the comparison example 3, if the tension T is made not less than 1.55×10⁻¹ N/mm (15.8 gf/mm) (to be more precise, 1.94×10⁻¹ N/mm), it is proved that the number of the concavities results in increase. In addition, according to the comparison example 4, if making the ratio (D1/D2) of the diameters of a hub and a pancake not more than 0.5 (to be more precise, 0.4), it is proved that the concavities do not recover even if a heat treatment is performed.

In addition, according to the examples 1 to 5, it is proved that dropout times are largely decreased, compared to the comparison examples 1 to 6. In addition, such a tendency is remarkable in cases that track widths are 5 μm and 8 μm; in a case that a track width is 14 μm, there does not almost exist a difference in both. Accordingly, it is proved that the manufacturing method of a magnetic tape related to the embodiment is specifically effective in a case that a track density is higher.

In addition, in the example 4 a concavity density after a heat treatment is 78 pieces/mm² and a dropout time is 4.5 times/m in the track width of 5 μm; whereas in the comparison example 5 the concavity density is 90 pieces/mm², the dropout time is 10 times/m in the track width of 5 μm, and those are not less than double in the example 3. Accordingly, if the concavity density is made not more than 80 pieces/mm², it is proved that the dropout time can be effectively decreased. In addition, although in the example 2 and the comparison example 6 concavity numbers are both 56 pieces/mm², the dropout time of the comparison example 6 is around 2 to 3.5 times more than that of the example 2 in the track widths of 5 μm and 10 μm. Thus it is proved that a heat treatment is effective in order to decrease a dropout time.

Thus, although the best mode for carrying out the present invention is described, referring to the drawings, the invention is not limited thereto and is changeable in a range of not departing from the spirit and scope of the invention.

For example, although in the embodiment the magnetic layer 3 and the back coat layer 4 are formed by a coating system, it is not limited thereto; for example, each of the layers may also be formed by any one of a sputtering method and a vapor deposition method.

In addition, as a coating method by a wet-on-wet system can be cited the following methods:

(1) A method of using any one of such a gravure coating apparatus, a roll coating apparatus, a blade coating apparatus, and an extrusion coating apparatus, firstly forming a non-magnetic layer on the support body 2, and then the magnetic layer 3 by a support-body pressurizing extrusion coating apparatus while the non-magnetic layer is wet (see Japanese Patent Laid-Open Publication No. S 60-238179, H1-46186, and H2-265672);

(2) A method of using a coating apparatus consisting of a single coating head equipped with two slits for coating a liquid and almost simultaneously forming the magnetic layer 3 and a non-magnetic layer (not shown) on the support body 2 (Japanese Patent Laid-Open Publication No. S63-88080, H2-17921, and 1H2-265672); and

(3) A method of using an extrusion coating apparatus with a backup roller and almost simultaneously forming the magnetic layer 3 and a non-magnetic layer (not shown) on the support body 2 (Japanese Patent Laid-Open Publication No. H2-174965).

In addition, although in the embodiment a magnetic tape is described as an example, the present invention is not limited thereto and is also applicable, for example, to a tape-form recording medium such an optical recording tape.

In addition, in the embodiment, although providing the strain relief process S3 and using the strain relief apparatus 20, it is assumed to relieve the strain of the bulk roll R2, the present invention is not limited thereto; for example, as in a case that the strain of the raw web 1 is smaller, when it is not necessary to provide the strain relief process S3, it goes without saying that such the process may be omitted. Even in a case of the omission, when making the raw web 1 like a roll, the minute convexities 4a are pushed to the front side of the magnetic layer 3 and the concavities 3a result in being formed; thus if applying the present invention to such the raw web 1, it is enabled to recover the concavities 3a.

In addition, in order to heighten the recovery effect of the concavities 3a, although the embodiment is configured to provide the heating apparatus 40 with the humidifier 43 and to increase the humidity of the storing unit 41, the present invention is not limited thereto and may not comprise the humidifier 43. Even in such the case it is enabled to recover the concavities 3a by heat treatment.

What is claimed is:

1. A manufacturing method of a tape-form recoding medium comprising:
a raw web winding process of winding on a winding core raw web having a support body, a data recoding layer laminated on one side of the support body, and a minute convexity laminated on the other side thereof; a raw web rewinding process of rewinding on other winding cores the raw web wound on the winding core in the raw web winding core; and
a heat treatment process of heating the rewound raw web and decreasing a number of a concavity not less than 30 nm in depth formed in the data recording layer in the raw web winding process to not more than 80 pieces/mm².

2. The manufacturing method according to claim 1, wherein a ratio (D1/D2) of a diameter D1 of the other winding cores to a diameter D2 of a pancake formed by rewinding the raw web on the other winding cores is in a range of an equation (1) below:
0.5≦D1/D2<1.0. Equation (1)

3. The manufacturing method according to claim 1, wherein a tension T per unit tape width in rewinding the raw web on the other winding cores is in a range of an equation (2) below:
7.7×10⁻² N/mm≦T≦1.55×10⁻¹ N/mm. Equation (2)

4. The manufacturing method according to claim 2, wherein a tension T per unit tape width in rewinding the raw web on the other winding cores is in a range of an equation (2) below:
7.7×10⁻² N/mm≦T≦1.55×10⁻N/mm. Equation (2)

5. The manufacturing method according to claim 1 further comprising a raw web slitting process of slitting the raw web, matching a desired width of the tape-form recoding medium.

6. The manufacturing method according to claim 2 further comprising a raw web slitting process of slitting the raw web, matching a desired width of the tape-form recoding medium.

7. The manufacturing method according to claim 3 further comprising a raw web slitting process of slitting the raw web, matching a desired width of the tape-form recoding medium.

8. The manufacturing method according to claim 4 further comprising a raw web slitting process of slitting the raw web, matching a desired width of the tape-form recoding medium.

9. The manufacturing method according to claim 1, wherein in the heat treatment process the raw web is heated for 12 to 48 hours under an environment of a temperature of 50 to 60 degrees Celsius and a humidity of 40 to 60%.

10. The manufacturing method according to claim 2, wherein in the heat treatment process the raw web is heated for 12 to 48 hours under an environment of a temperature of 50 to 60 degrees Celsius and a humidity of 40 to 60%.

11. The manufacturing method according to claim 3, wherein in the heat treatment process the raw web is heated for 12 to 48 hours under an environment of a temperature of 50 to 60 degrees Celsius and a humidity of 40 to 60%.

12. The manufacturing method according to claim 4, wherein in the heat treatment process the raw web is heated for 12 to 48 hours under an environment of a temperature of 50 to 60 degrees Celsius and a humidity of 40 to 60%.

13. The manufacturing method according to claim 5, wherein in the heat treatment process the raw web is heated for 12 to 48 hours under an environment of a temperature of 50 to 60 degrees Celsius and a humidity of 40 to 60%.

14. The manufacturing method according to claim 6, wherein in the heat treatment process the raw web is heated for 12 to 48 hours under an environment of a temperature of 50 to 60 degrees Celsius and a humidity of 40 to 60%.

15. The manufacturing method according to claim 7, wherein in the heat treatment process the raw web is heated for 12 to 48 hours under an environment of a temperature of 50 to 60 degrees Celsius and a humidity of 40 to 60%.

16. The manufacturing method according to claim 8, wherein in the heat treatment process the raw web is heated for 12 to 48 hours under an environment of a temperature of 50 to 60 degrees Celsius and a humidity of 40 to 60%.

17. The tape-form recoding medium manufactured by the manufacturing method of the tape-form recoding medium according to claim 1.

18. The tape-form recoding medium manufactured by the manufacturing method of the tape-form recoding medium according to claim 2.

19. The tape-form recoding medium manufactured by the manufacturing method of the tape-form recoding medium according to claim 3.

20. The tape-form recoding medium manufactured by the manufacturing method of the tape-form recoding medium according to claim 5.
